(19) United States
(12) Patent Application Publication
(10) Pub. No.: US 2011/0214549 A1
(43) Pub. Date: Sep. 8, 2011

(54) BOARD CUTTING DEVICE

(76) Inventor: Chiang-Tung Shih, Taichung (TW)

(21) Appl. No.: 12/825,310

(22) Filed: Jun. 28, 2010

Related U.S. Application Data
(63) Continuation-in-part of application No. 12/719,027, filed on Mar. 8, 2010.

(51) Int. Cl. B26D 5/10

(52) U.S. Cl. 83/606

(57) ABSTRACT

The present invention discloses a board cutting device, which comprises a base frame, a push stem, a blade, a first one-direction driving mechanism, and a second one-direction driving mechanism. One end of the push stem is linked with the base frame, and there is a handle at the other end. The blade is attached on the push stem and is able to simultaneously revolve with the push stem relative to the base frame. The middle portion of the blade is a protruded cutting arc. The first one-direction driving mechanism is utilized to adjust the angle between the push stem and the blade automatically, and the second one-direction driving mechanism can be utilized to control the automatic positioning of the downward cutting blade. Therefore, the blade can avoid arbitrary departing from the prep board and the device is able to achieve the object of better manipulation, less strenuous effort, and more accurate cutting.

### RELATED APPLICATION

This application is based upon and claims the benefit of priority from prior U.S. patent application Ser. No. 12/719,027 filed on 8 Mar. 2010, and is a Continuation-in-Part of U.S. application Ser. No. 12/719,027, entitled “BOARD CUTTING DEVICE”, naming Chiang-Tung Shih as inventor, and filed on 8 Mar. 2010.

### FIELD OF THE INVENTION

The present invention relates to a board cutting device, particularly to a device comprising a base frame, a push stem, a blade, a first one-direction driving mechanism for adjusting the angle of the exerted force from the push stem, and a second one-direction driving mechanism for positioning the downward cutting blade.

### BACKGROUND OF THE INVENTION

Inasmuch as most wood floors are composed of strips of boards, the wood boards must be cut into the same length before being paved indoors or outdoors. During the paving process, there must be areas that can't fit in a whole piece of the wood strip. The solution is to cut wood boards into corresponding sizes for paving these irregular areas. No matter indoors or outdoors, the beauty and integrity of overall design or layout can only be presented by doing so.

The prior art of a manual board cutting device, shown as FIG. 10, comprises a base frame 80, a blade 81 and a push stem 82. The base frame 80 includes a platform 83 for wood boards to be placed and a receiving slot 84 opened on the platform 83. One end of the blade 81 and the push stem 82 are firmly pivotally connected together, and the other end is joined with the base frame 80. When the device is employed to cut a prep board, the push stem 82 is lifted up and so is the blade 81. Thus, the board can be placed on top of the platform 83 and the push stem 82 can be pressed down to drive the blade 81 down and to cut the board.

There are certain disadvantages of the prior art. For example, the push stem 82 and the blade 81 can't be relatively revolved to adjust the angle of the exerted force between them, and the blade 81 can't be accurately positioned while cutting downward. Hence, when the prior art is employed to cut a board, it would cause inconvenient manipulation, strenuous effort, and inaccurate cutting due to the blade departing from the board and so on.

### SUMMARY OF THE INVENTION

The object of the present invention is to provide a board cutting device, which has multistage function of adjusting the angle of the exerted force and the function of automatic positioning the downward cutting blade, for better manipulation, less strenuous effort, and more accurate cutting.

In order to achieve the foregoing object, the present invention is designed to comprise a base frame, a push stem, a blade, a first one-direction driving mechanism, and a second one-direction driving mechanism. The blade can be simultaneously revolved against the base frame along with the push stem, the first one-direction driving mechanism can be utilized to adjust the angle between the push stem and the blade automatically, and the second one-direction driving mechanism can be utilized to control the automatic positioning of the downward cutting blade.

### BRIEF DESCRIPTION OF THE DRAWINGS

FIG. 1 is an exploded schematic drawing of the main parts in accordance with the present invention;

FIG. 2 is an assembled schematic drawing of the present invention;

FIG. 3 is a schematic drawing of the downward cutting blade and the push stem relative to the blade in accordance with the present invention;

FIG. 4 is a schematic drawing of a board being placed on the base frame in accordance with the present invention;

FIG. 5 is a schematic drawing of a board being cut by the blade in accordance with the present invention;

FIG. 6 is an assembled schematic drawing of the base frame, the push stem and the blade in accordance with the present invention;

FIG. 7 is a partial assembled schematic drawing of the linkage in accordance with the present invention;

FIG. 8 is a schematic drawing of the blade being firmly engaged in accordance with the present invention;

FIG. 9 is an assembled schematic drawing of the limit plate and the platform in accordance with the present invention; and

FIG. 10 is a schematic drawing of a prior art.

### DETAILED DESCRIPTION OF THE PREFERRED EMBODIMENT

### I. Features of Fundamental Arts of the Present Invention

The present invention is mainly applied to cutting boards such as wood floor boards. By means of innovation of mechanic design, the present invention is able to provide a board cutting device, which has multistage function of adjusting the angle of the exerted force and the function of automatic positioning the downward cutting blade, for better manipulation, less strenuous effort, and more accurate cutting.

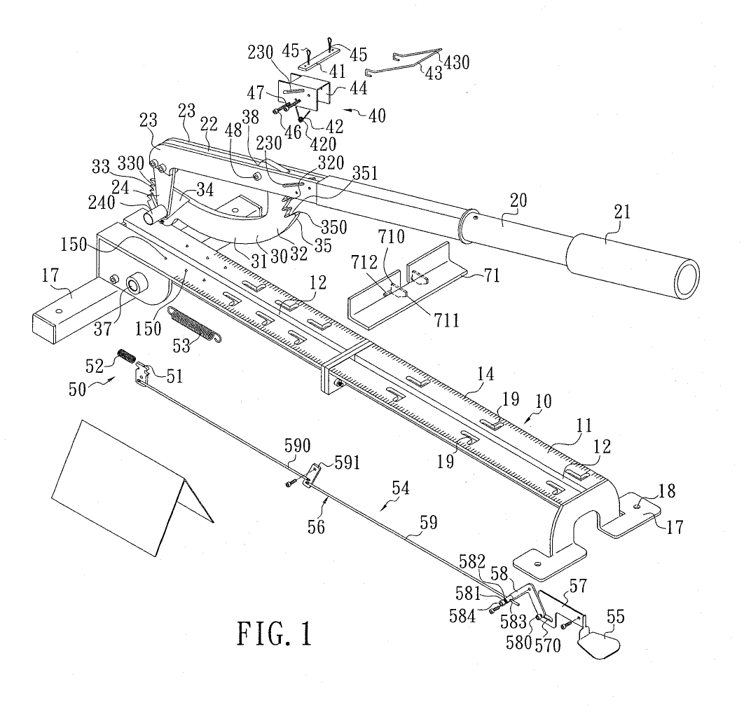

Referring to FIG. 1, the mechanism of the present invention is designed to comprise a base frame 10, a push stem 20, a blade 30, a first one-direction driving mechanism 40, a first release assembly 43, a second one-direction driving mechanism 50 and a second release assembly 54 in order to achieve the foregoing object. The base frame 10 is provided to be steadily placed on a leveled surface, and on the top of the base frame 10 is provided a platform 11 for materials such as wood floor boards to be laid on. A receiving slot 12 is opened on the platform 11 and the blade 30 is affixed to the push stem 20. When the external force is exerted on the push stem 20, the blade 30 will revolve against the base frame 10 along with the push stem 20. The middle portion of the blade 30 is a protruded cutting arc 31. When the blade 30 revolves against the base frame 10, the cutting arc 31 will be inlaid into the receiving slot 12 to cut prep boards.

Referring to FIG. 1, in order to achieve the foregoing object, the mechanic features of the present invention are: a front end of the push stem 20 is pivotally connected with the blade 30 for the push stem 20 being able to revolve against the blade 30; the first one-direction driving mechanism 40 and the first release assembly 43 are installed between the push stem 20 and the blade 30, the first one-direction driving mechanism 40 is acted to control the relative revolution of the blade 30 against the push stem 20 only for increasing their included angle, so the angle of the exerted force of the push stem 20 is able to be automatically adjusted; a front end of the blade 30 pivotally connected upon the base frame 10; the second one-direction driving mechanism 50 and the second release assembly 54 are installed between the blade 30 and the base frame 10, the second one-direction driving mechanism 50 is acted to control the relative revolution of the blade 30 against the base frame 10 only for decreasing their included angle, so that the cutting angle of the blade 30 is able to be prevented from arbitrarily departing from the board; and when the second release assembly 54 is activated, the second one-direction driving mechanism 50 stops action so that the blade 30 is able to arbitrarily revolve against the base frame 10.

### II. Embodiments of the Present Invention

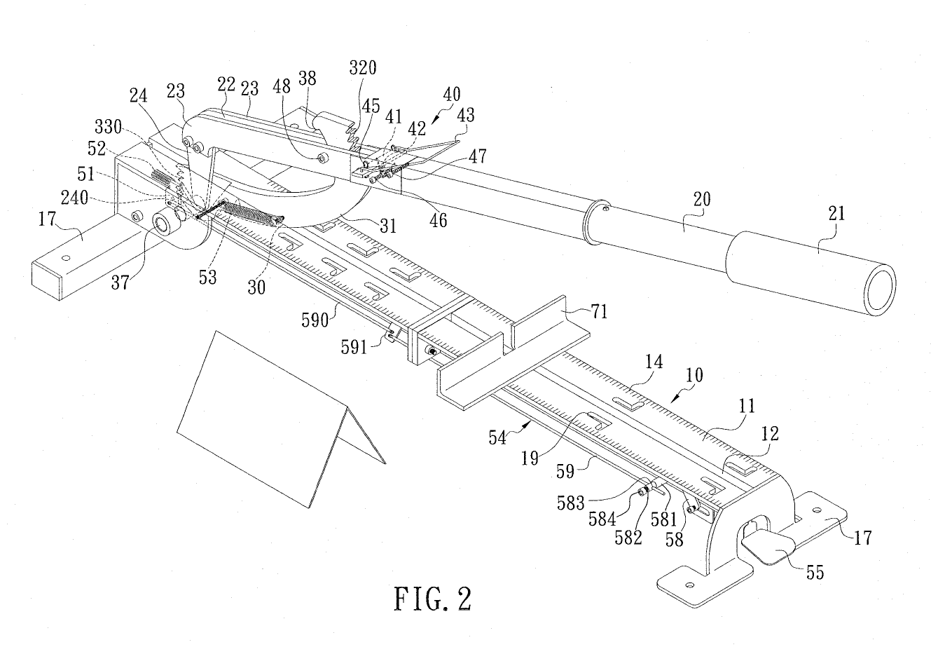

FIG. 1 and FIG. 2 show the embodiments of the first one-direction driving mechanism 40 and the first release assembly 43 of the present invention. At the rear end of the blade 30 is an extended first arc portion 32, the center of the first arc portion 32 coincides with the pivotal axis of the blade 30 and the push stem 20, and the first arc portion 32 is provided a plurality of first ratchet teeth 320 thereon. On the push stem 20 is mounted with a first pawl 41 and a first spring 42, the first spring 42 provides required elasticity for the first pawl 41. There is also a slotting 22 on the push stem 20 for the first arc portion 32 of the blade 30 to pass through. Two shafts 46/47 are inserted through both inner portion of the slotting 22 and a cover 44 which partially conceals the outer portion of the slotting 22. Both the slotting 22 and the cover 44 are penetrated by a first guiding hole 230, and the first pawl 41 is movably installed through the first guiding hole 230. Each end of the first pawl 41 has a pin 45. The first release assembly 43 has a tab 430 which directly connects to the first pawl 41. The first spring 42 is a torque spring 420 which loops upon the shaft 46. One end of the torque spring 420 is against the shaft 47 and the other end of the torque spring 420 is against the first pawl 41. When the first pawl 41 takes the elasticity from the first spring 42, it will be automatically engaged with the first ratchet teeth 320 for the blade 30 to revolve relative to the push stem 20 only for increasing their included angle. When the pulling force exerted on the tab 430 overcomes the elasticity from the first spring 42, the first pawl 41 is therefore withdrew, along the first guiding hole 230 of the push stem 20, from the first ratchet teeth 320 so that the first one-direction driving mechanism 40 stops action and the blade 30 is able to arbitrarily revolve against the push stem 20. Furthermore, there is another better embodiment. A limit rod 48 is installed in the slotting 22, and a first limit edge 38 and a second limit edge 350 are provided on the blade 30. The first limit edge 38 holds the limit rod 48 and the second limit edge 350 wedges the first pawl 41 so that the blade 30 can be limited to revolve relative to the push stem 20 within a specific range of angles.

FIG. 1 and FIG. 2 also show the embodiments of the second one-direction driving mechanism 50 and the second release assembly 54 of the present invention. At the front end of the blade 30 has a second arc portion 33, the center of the second arc portion 33 coincides with the pivotal axis of the of the blade 30 and the base frame 10, the second arc portion 33 is provided with a plurality of second ratchet teeth 330 thereon. On the base frame 10 are mounted with a second pawl 51 and a second spring 52, the second spring 52 provides required elasticity for the second pawl 51. The second release assembly 54 comprises a pedal 55 and a linkage assembly 56. The linkage assembly 56 is employed to link the second pawl 51 and the pedal 55. When the second pawl 51 takes the elasticity from the second spring 52, it will be automatically engaged with the second ratchet teeth 330 for the blade 30 to relatively revolve against the base frame 10 only for decreasing their included angle. When the stepping force passed through the linkage assembly 56 exerts on the pedal 55 and is hard enough to overcome the elasticity from the second spring 52, the second pawl 51 is therefore withdrew from the second ratchet teeth 330 so that the second one-direction driving mechanism 50 stops action and the blade 30 is to be able to revolve against the base frame 10 increasing or decreasing their included angle (i.e. at wider or smaller angles). Furthermore, there is another better embodiment. The linkage assembly 56 comprises a first L-shape linkage 57, a second L-shape linkage 58, a first linking string 59, a second linking string 590 and a rotating member 591. The middle portion of the first L-shape linkage 57 is pivotally installed upon the base frame 10, the rear end of the first L-shape linkage 57 is fixed with the pedal 55, and the front end of the first L-shape linkage 57 has a long opening 570. The middle portion of the second L-shape linkage 58 is also pivotally installed upon the base frame 10, the rear end of the second L-shape linkage 58 has a pivot 580 inserted through the long opening 570 of the first L-shape linkage 57, and the front end of the second L-shape linkage 58 has a column 581 with a screw hole 582 at its distal end. A string hole 583 transversely penetrates the periphery of the column 581 and the screw hole 582, and a fastening screw 584 is screwed into the screw hole 582. The rear end of the first linking string 59 is inserted into the string hole 583 through the column 581 and tightened by the distal end of the fastening screw 584 to adjust the tension of the linkage assembly 56. The front end of the second linking string 590 is pivotally connected or hooked with the second pawl 51. One end of the rotating member 591 is pivotally installed on the base frame 10, and the other end is connected with both the front end of the first linking string 59 and the rear end of the second linking string 590. When the pedal 55 is stepped, the stepping force will consequently make the first L-shape linkage 57 revolve and then pull the second L-shape linkage 58 to revolve as well. The second L-shape linkage 58 pulls the first linking string 59 which makes the rotating member 591 revolve and trigger the second linking string 590 to pull the second pawl 51 to revolve. Therefore, the second pawl 51 presses the second spring 52 and departs from the second ratchet teeth 330, so that the second one-direction driving mechanism 50 stops action and the blade 30 is able to arbitrarily revolve against the base frame 10

Referring to FIG. 1, the blade 30 of the present invention has the function of automatically repositioning itself up. There is a pulling spring 53 between the blade 30 and the base frame 10, and the pulling force from the spring 53 is able to make the blade 30 automatically widen its angle relative to the base frame 10.

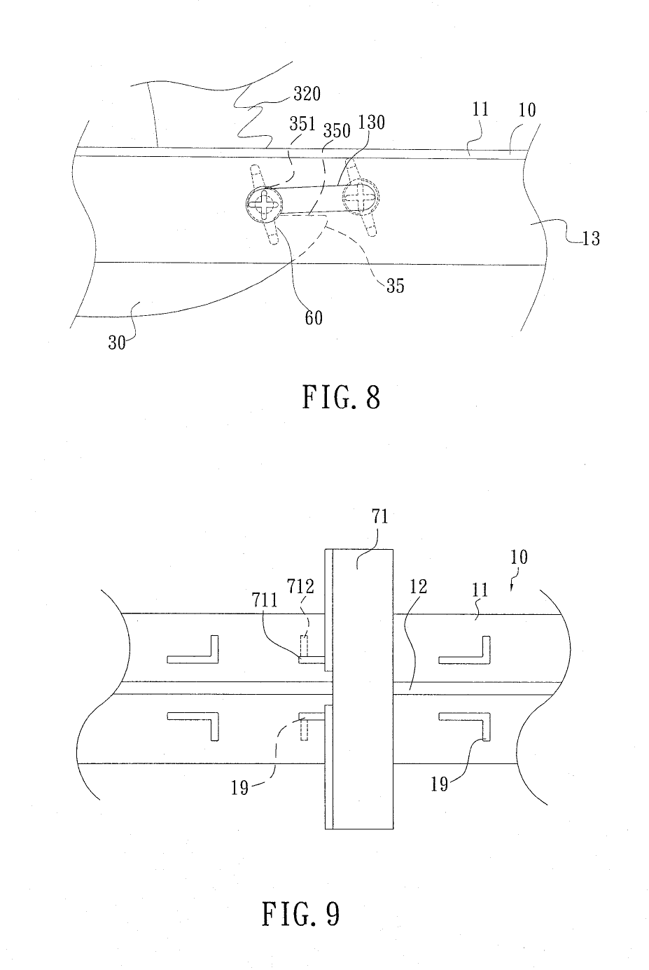

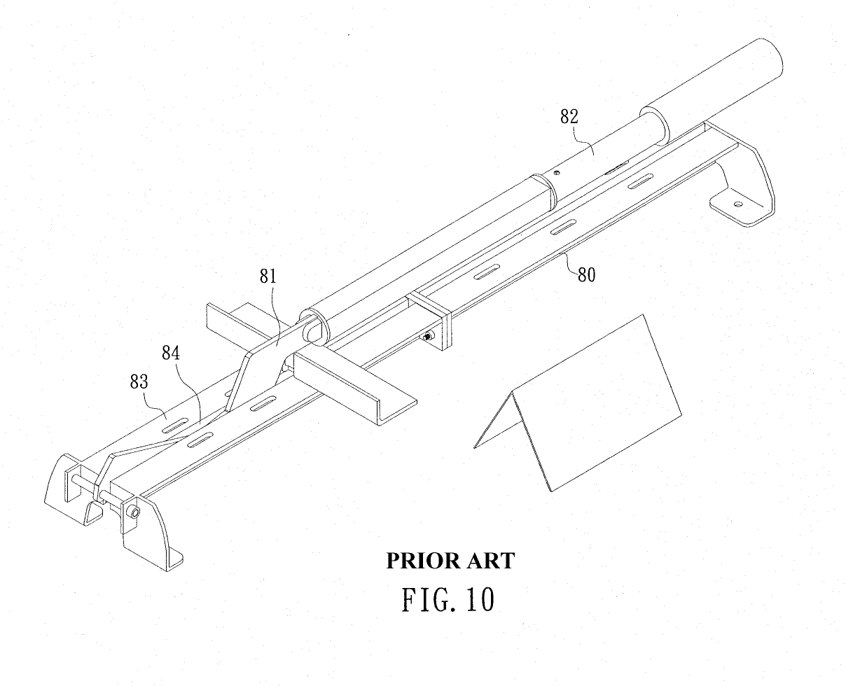

Referring to FIG. 1 and FIG. 8, the present invention has the function of positioning when the blade 30 is retrieved back to the base frame 10. There are a cog 35, which is located at the rear end of the blade 30 next to the first arc portion 32, protruded with a length longer than those of the first ratchet teeth 320, and a concave 351 formed between a first ratchet teeth 320 and the cog 35. There is a long groove 130 provided transversely penetrating the receiving slot 12 of the base frame 10 for an anchor cog 60 to be inserted and be able to move along the groove 130. When completing the cutting work, the user can move the blade 30 into the receiving slot 12, and push the anchor cog 60 to move along the long groove 130 and then clutch at the concave 351 for the blade 30 to be fixed upon the base frame 10.

Referring to FIG. 1, the present invention has the function of measuring the sizes of boards which are about to be cut. There is a ruler scale 14 indicated along the receiving slot 12 on top of the platform 11.

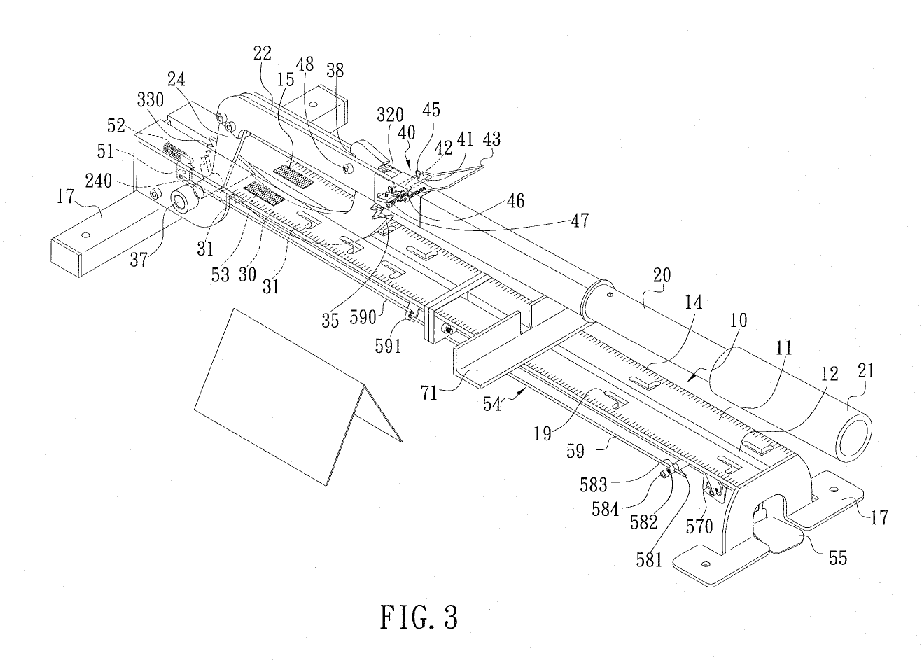

Referring to FIG. 1, the present invention has the function of preventing boards from slipping away. There is a plurality of nails 150 provided on the platform 11 as shown in FIG. 1. There are two anti-slip pads 15 applied in parallel on the top of the platform 11 as shown in FIG. 3.

Referring to FIGS. 1 and 9, the present invention has the function of limiting the position of a prep board 1. There is a limit plate 71 installed on the platform 11 to hold the prep board 1. The detailed mechanism is to apply a plurality of limit structure on the platform 11. Each limit structure has two symmetric L-shape grooves 19 back-to-back aligned along the receiving slot 12. Two flat pieces 711 are attached on the bottom of the limit plate 71 and each flat piece 711 has a limit hook 712 laterally extended from its distal end. The limit hook 712 is inserted from one side of the L-shape groove 19 and then hooked at the bottom of the platform 11, and the flat piece 711 is inserted into the other side of the L-shape groove 19.

Referring to FIG. 1, the present invention has the function of stabilizing the base frame 10. There is at least a protruding edge 17 laterally extended from the bottom of the base frame 10. The protruding edge 17 allows a user to step on it or to fasten it on the working surface with screws lucked in the holes 18 provided on the protruding edge 17.

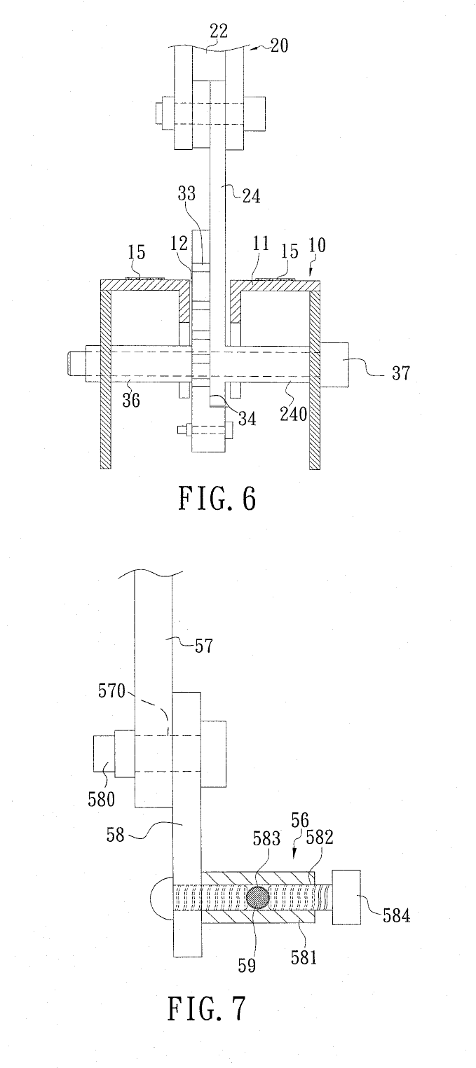

Referring to FIG. 1 and FIG. 6, the present invention has a better embodiment of assembling the push stem 20 and the blade 30 on the base frame 10. A connecting member 24 is extended slantwise from the front end of the push stem 20. A front end of the connecting member 24 has opposite a first side and a second side, and a first sleeve 240 is laterally extruded from the first side. The front end of the blade 30 has opposite a first side and a second side, an arched trough 34 is formed on the first side, the second side of the connecting member 24 is mounted in the arched trough 34, a second sleeve 36 is laterally extruded from the second side of the blade 30; and the first sleeve 240 and the second sleeve 36 are aligned and coaxially joined together with the base frame 10 by a pivotal shaft 37.

### III Operations of the Present Invention

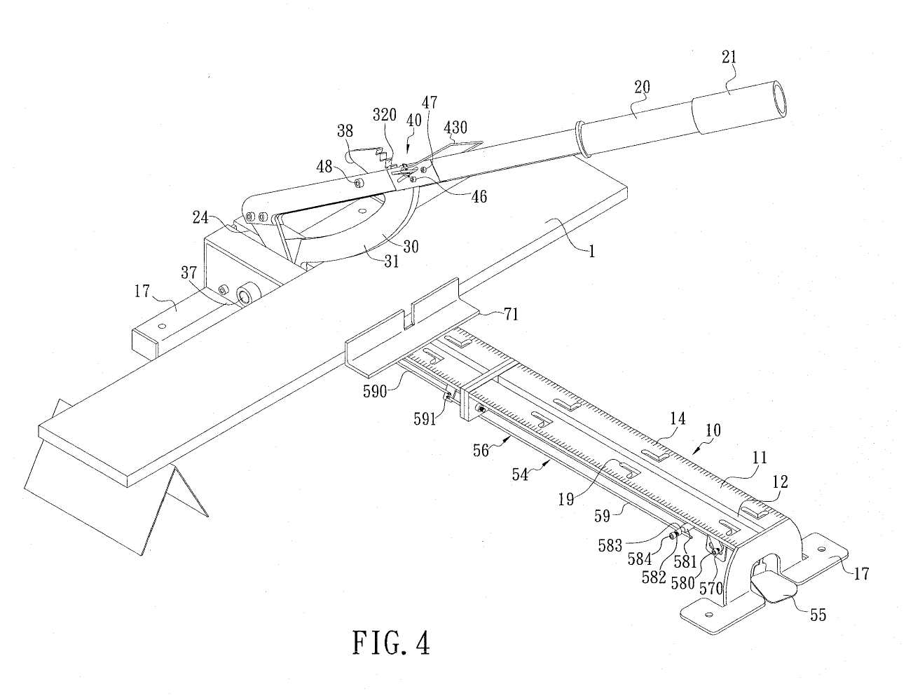

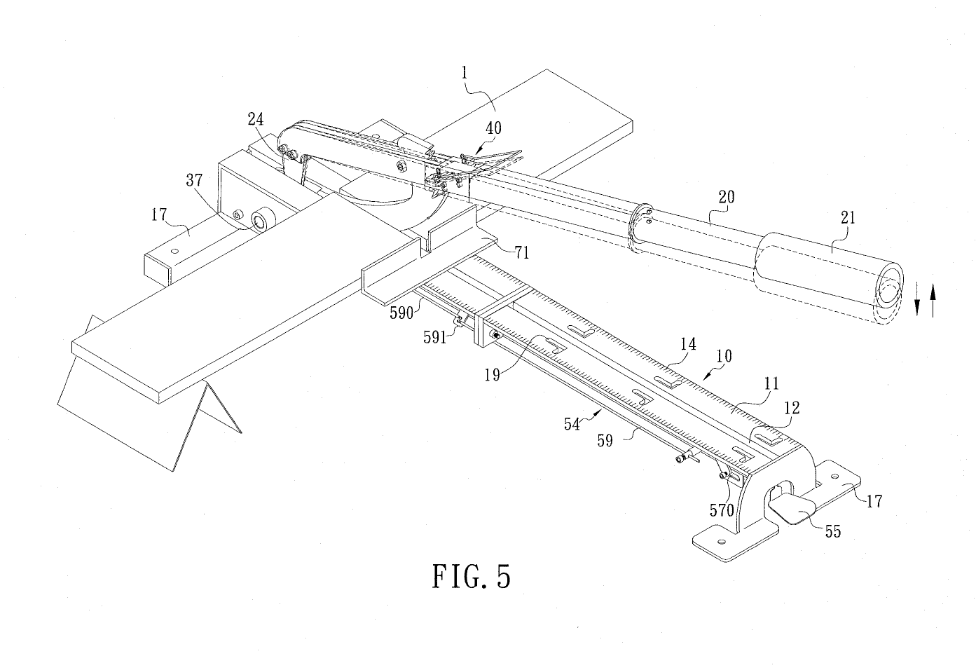

Referring to FIG. 4, when the blade 30 is fully opened relative to the base frame 10, a user may place a prep board 1 on the top of the platform 11 and hold the handle 21 to press down the push stem 20. Due to the action of the first one-direction driving mechanism 40, the push stem 20 is able to regularly drive the blade 30 downward to cut the prep board 1 shown as FIG. 5. In the mean time, because the second one-direction driving mechanism 50 is automatically acted, the blade 30 won't be able to move upward against the base frame 10 and to depart from the prep board 1. If the user wishes to keep applying force to proceed to cut, he can pull the push stem so as to increase the inclination angle of the push stem, and promote the facility of operation. Due to the function of the first one-direction driving mechanism 40, the push stem 20 is able to widen its angle against the blade 30. Therefore, the best angle to apply force can be reached by moving the push stem 20 upward against the base frame 10 shown as the moving status in FIG. 5. To be pressed down again, the push stem 20 will drive the blade 30 downward to proceed cutting the prep board 1. As depicted above, the prep board 1 can be cut promptly and accurately by repeatedly moving the push stem 20 up and down several times.

Referring to FIG. 3, after the cutting is done, the second release assembly 54 will be functioned to recover the device for next cutting. When the user steps on the pedal 55, the linkage assembly 56 pulls the second pawl 51 to revolve. The second pawl 51 presses the second spring 52 and departs from the second ratchet teeth 330. Therefore, the second one-direction driving mechanism 50 will stops action, the push stem 20 and the blade 30 will be pulled upward relative to the base frame 10 by the spring 53, and the cutting device will be ready for next operation.

While we have shown and described the embodiment in accordance with the present invention, it should be clear to those skilled in the art that further embodiments may be made without departing from the scope of the present invention.

What is claimed is:

1. A board cutting device comprising a base frame, a push stem and a blade; the base frame being to be steadily placed on a leveled surface, a top of the base frame being provided a platform for a board to be laid on, a receiving slot being opened on the platform; the blade affixed to the push stem, the middle portion of the blade being a protruded cutting arc; as the external force being exerted on the push stem, the blade revolving against the base frame along with the push stem, the cutting arc being inlaid into the receiving slot to cut the board; wherein:
a front end of the push stem being pivotally connected with the blade for the push stem being able to revolve against the blade; a first one-direction driving mechanism and a first release assembly being installed between the push stem and the blade, the first one-direction driving mechanism being acted to control the relative revolution of the blade against the push stem only for increasing their included angle, and as the first release assembly being activated, the first one-direction driving mechanism stopping action so that the push stem being able to arbitrarily revolve against the blade; a front end of the blade being pivotally connected with the base frame, a second one-direction driving mechanism and a second release assembly being installed between the blade and the base frame, the second one-direction driving mechanism being acted to control the relative revolution of the blade against the base frame only for decreasing their included angle, and as the second release assembly being activated, the second one-direction driving mechanism stopping action so that the blade being able to arbitrarily revolve against the base frame.

2. The board cutting device as claimed in claim 1, wherein the first one-direction driving mechanism includes an extended first arc portion provided at a rear end of the blade, the first arc portion is provided a plurality of first ratchet teeth thereon; the center of the first arc portion coincides with the pivotal axis of the blade and the push stem; a first pawl and a first spring are provided on the push stem, the first spring provides required elasticity for the first pawl; the first release assembly has a tab which directly connects to the first pawl; as the first pawl takes the elasticity from the first spring, the first pawl automatically engages with the first ratchet teeth so that the first one-direction driving mechanism acts; and as the pulling force exerted on the tab overcomes the elasticity from the first spring, the first pawl will be withdrew from the first ratchet teeth so that the first one-direction driving mechanism stops action.

3. The board cutting device as claimed in claim 2, wherein there is a slotting provided on the push stem for the first arc portion on the blade to pass through; a cover partially conceals the outer portion of the slotting, and a first guiding hole penetrates both the slotting and the cover; the first pawl is movably installed through the first guiding hole and each end of the first pawl has a pin; two shafts are laterally inserted through both inner portion of the slotting; and the first spring is a torque spring whose middle portion loops on one shaft, one end of the first spring is against the other shaft, and the other end is against the first pawl.

4. The board cutting device as claimed in claim 3, wherein a limit rod is installed in the slotting, and a first limit edge and a second limit edge are set on the blade; and the first limit edge holds the limit rod and the second limit edge wedges the first pawl so that the blade is limited to revolve relative to the push stem within a specific range of angles.

5. The board cutting device as claimed in claim 1, wherein the second one-direction driving mechanism includes a second arc portion provided at the front end of the blade, the center of the second arc portion coincides with the pivotal axis of the blade and the base frame, the second arc portion is provided a plurality of second ratchet teeth thereon; a second pawl and a second spring being provided on the base frame, the second spring provides required elasticity for the second pawl; the second release assembly comprises a pedal and a linkage assembly, and the linkage assembly is employed to link the second pawl and the pedal; as the second pawl takes the elasticity from the second spring, the second pawl automatically engages with the second ratchet teeth so that the second one-direction driving mechanism acts; and as the stepping force passed through the linkage assembly exerts on the pedal and is hard enough to overcome the elasticity from the second spring, the second pawl is therefore withdrew from the second ratchet teeth so that the second one-direction driving mechanism stops action.

6. The board cutting device as claimed in claim 5, wherein the linkage assembly comprises:
a first L-shape linkage with a middle portion being installed upon the base frame, a rear end of the first L-shape linkage being fixed the pedal, and a front end of the first L-shape linkage having a long opening;
a second L-shape linkage with a middle portion being installed upon the base frame, a rear end of the second L-shape linkage having a pivot inserted through the long opening of the first L-shape linkage, and a front end of the second L-shape linkage having a column, the distal end of the column provided a screw hole thereon for a fastening screw to be screwed, and a string hole being provided transversely passing through the column and the screw hole;
a first linking string with a rear end being inserted into the string hole through the column and tightened by the distal end of the fastening screw;
a second linking string with a front end being connected with the second pawl; and
a rotating member with an end being pivotally installed on the base frame and with the other end being connected both a front end of the first linking string and a rear end of the second linking string;
as the pedal being stepped, the stepping force consequently making the first L-shape linkage to revolve and then pull the second L-shape linkage to revolve as well; the second L-shape linkage pulling the first linking string which makes the rotating member revolve and then trigger the second linking string to pull the second pawl to revolve; and the second pawl, therefore, pressing the second spring and departing from the second ratchet teeth.

7. The board cutting device as claimed in claim 1, wherein there is a pulling spring between the blade and the base frame, and the pulling force from the spring is able to make the blade automatically widen its angle relative to the base frame.

8. The board cutting device as claimed in claim 1, wherein there is a ruler scale indicated along the receiving slot on a top of the platform.

9. The board cutting device as claimed in claim 1, wherein a plurality of nails is provided on the platform.

10. The board cutting device as claimed in claim 1, wherein there is a limit plate installed on the platform to hold the board.

11. The board cutting device as claimed in claim 10, wherein there is a plurality of limit structure on the platform; each limit structure has two symmetric L-shape grooves; two flat pieces are attached on a the bottom of the limit plate and a distal end of each flat piece is provided a limit hook laterally extended therefrom; the limit hook is inserted from one side of the L-shape groove and then hooked at the bottom of the platform; and the flat piece is inserted into the other side of the L-shape groove.

12. The board cutting device as claimed in claim 1, wherein a connecting member is extended slantwise from the front end of the push stem, a front end of the connecting member has opposite a first side and a second side, and a first sleeve is laterally extruded from the first side; the front end of the blade has opposite a first side and a second side, an arched trough is formed on the first side, the second side of the connecting member is mounted in the arched trough, a second sleeve is laterally extruded from the second side of the blade; and the first sleeve and the second sleeve are aligned and coaxially joined together on the base frame by a pivotal shaft.
